(19) United States
(12) Patent Application Publication
(10) Pub. No.: US 2007/0168879 A1
(43) Pub. Date: Jul. 19, 2007

(54) Traversal of datasets using positioning of radial input device

(75) Inventors: Brendan K. Reville, Seattle, WA (US); Dan B. Kroymann, Kirkland, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/333,965

(22) Filed: Jan. 17, 2006

(51) Int. Cl. G06F 9/00; G06F 3/00

(52) U.S. Cl. 715/810; 715/834; 715/835

(57) ABSTRACT

Items can be displayed radially by positioning representative icons in a circular or helical fashion on a display. Upon receiving an angle input from a radial input device, an item at a corresponding angle on the display can be selected. The set of selectable items can be recalculated with each new selection, thereby removing the constraint of available display space and allowing easy and continuous traversal of even very large datasets.

### BACKGROUND

Navigation of datasets using a radial input device such as the thumbstick on a video-game controller can be a tedious task. For example, those familiar with the popular XBOX® videogame system made by MICROSOFT® corporation of Redmond, WA are also familiar with the difficulty of entering text using the controller. In that system, entering text is accomplished by selecting letters from a Graphical User Interface (GUI) that provides an image of a keyboard on the screen. The user can navigate among the letters using the thumbstick, and select desired letters by pressing a button on the controller.

Navigation of larger datasets may entail either item by item traversal of very long lists, or a paging system to page through subsets of data. For example, consider a familiar set of steps that can be required to select and play a desired song. Songs can be grouped by album, and albums can be grouped by genre. The user traverses a list of genres item by item, and selects a first genre, e.g., grunge. The user next traverses a list of album titles item by item, and selects a desired album, e.g., “Nevermind” by Nirvanna. Finally, the user traverses a list of songs item by item, and selects a desired song, “Come as you are.”

A radial selection approach may improve on the general model above in some contexts. For example, RAINBOW SIX® game software manufactured by UBISOFT® of Montreuil-sous-Bois, France, uses a circular GUI that allows quick, intuitive selection of items by aiming a radial input device in an angle corresponding to the angle of the item on the GUI. For example, a user might select a letter of the alphabet by viewing a GUI with the letters arranged in a circle, and aiming the thumbstick in the direction of one of them, then pressing a button on the controller to select the letter. One problem with this system is that there are a limited number of items that a user can practically view and select from the GUI. While selection of a letter of the alphabet may be convenient, it is less convenient to select items from larger datasets, and a paging system similar to the one described above may be required. Using right and left game controller triggers to display additional datasets, for example to switch between alphabetical letters and symbols, expands the number of selectable items only somewhat.

In light of the above described difficulties in navigating datasets with a radial input device, there is a need in the industry for faster, more intuitive navigation techniques.

### SUMMARY

In consideration of the above-identified shortcomings of the art, the present invention provides systems and methods for traversal of datasets using positioning of a radial input device. Items can be displayed radially by positioning representative icons in a circular or helical fashion on a display. Upon receiving an angle input from a radial input device, an item at a corresponding angle on the display can be selected. The set of selectable items can be recalculated with each new selection, thereby removing the constraint of available display space and allowing easy and continuous traversal of even very large datasets. Other advantages and features of the invention are described below.

### BRIEF DESCRIPTION OF THE DRAWINGS

The systems and methods for traversal of datasets using positioning of a radial input device in accordance with the present invention are further described with reference to the accompanying drawings in which:

FIG. 1 illustrates a game controller 101 comprising a radial input device 107, a computer 102, and a display 103, configured so that positioning the radial input device 107 at an angle 106 selects an item 104 positioned at said angle 105;

FIG. 2 illustrates a method for displaying a plurality of selectable items.

FIG. 3 illustrates a computer comprising computer readable media for generating a radial GUI with radial selection functionality as well as dynamic updates to the GUI.

FIG. 4 illustrates an exemplary embodiment of a GUI with selectable items arranged on a helix, the axis of the helix perpendicular to the display, in which a first item is radially selected and a first plurality of selectable items is presented based on proximity to said first item in a list of selectable items.

FIG. 5 illustrates a next view of the exemplary embodiment in FIG. 4, in which a second item is radially selected, and a second plurality of selectable items is presented based on proximity to said second item in the list.

FIG. 6 illustrates a next view of the exemplary embodiment in FIG. 4, in which a third item is radially selected, and a third plurality of selectable items is presented based on proximity to said third item in the list.

FIG. 7 illustrates a next view of the exemplary embodiment in FIG. 4, in which a fourth item is radially selected, and a fourth plurality of selectable items is presented based on proximity to said fourth item in the list.

### DETAILED DESCRIPTION

Certain specific details are set forth in the following description and figures to provide a thorough understanding of various embodiments of the invention. Certain well-known details often associated with computing and software technology are not set forth in the following disclosure, however, to avoid unnecessarily obscuring the various embodiments of the invention. Further, those of ordinary skill in the relevant art will understand that they can practice other embodiments of the invention without one or more of the details described below. Finally, while various methods are described with reference to steps and sequences in the following disclosure, the description as such is for providing a clear implementation of embodiments of the invention, and the steps and sequences of steps should not be taken as required to practice this invention.

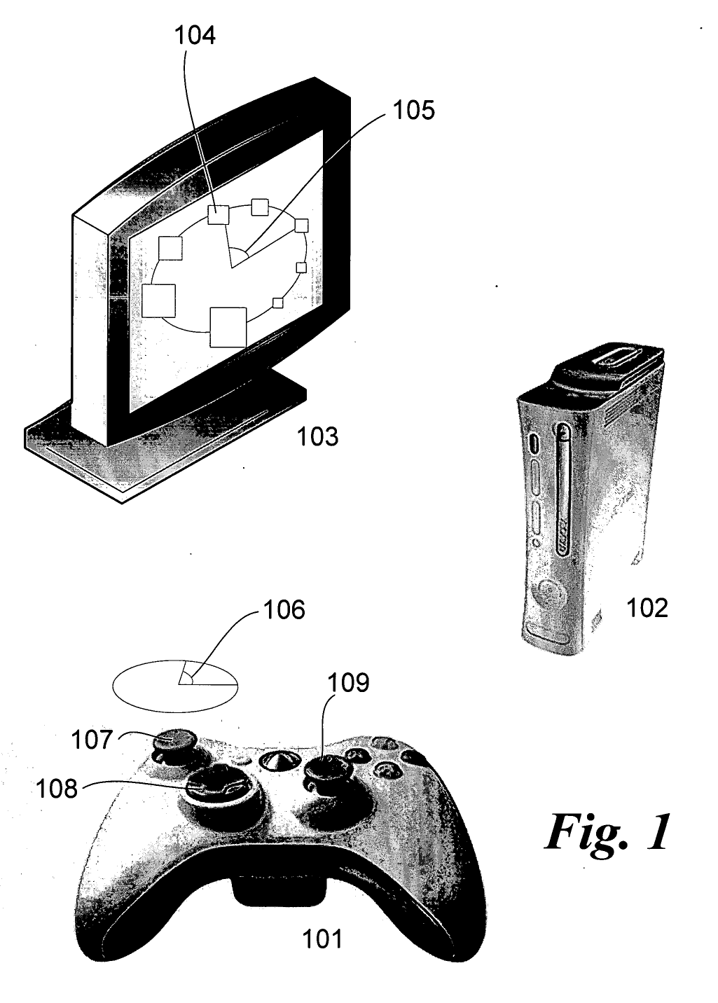

FIG. 1 illustrates a system for selecting graphically displayed items comprising a computer 102, a display 103 operably coupled to said computer 102, and a radial input device 101 operably coupled to said computer 102.

A display 103 may be, for example, a television, a computer monitor, a projector, and a display integrated into a device such as a portable videogame player, PDA, or cell phone. Displays are commonly manufactured as Cathode Ray Tubes (CRT) and Liquid Crystal Displays (LCD), but can also be implemented any number of other ways. A display is any device capable of presenting an image to a user.

A radial input device 101 can be, for example, a thumbstick such as 107 and 109, a circular pad such as 108, a plurality of arrow keys, e.g., arrow keys on a keyboard, indicating radial directions, a joystick, a mouse, a touch screen, and a trackball. The radial input device can be integrated with a videogame controller 101, or a keyboard, mouse, or other input device. A radial input device is any device capable of sending a signal with an indication of a selected angle to a computer.

A computer 102 may be, for example, a gaming console such as the XBOX®, the PLAYSTATION®, and the GAMECUBE®. It may also be a Personal Computer (PC), laptop computing device, portable device, networked server, or computer that is integrated into the wide variety of machines and devices, such as cell phones, PDAs, automobiles, and airplanes. A computer is any electronic device that has a processor and a memory.

The computer 102 is configured to cause a Graphical User Interface (GUI) comprising a plurality of selectable items, such as exemplary item 104 to appear on a display 103. A GUI generally presents images to a user, whereby the user can select one or more of the images to access desired functions or content. For example, a GUI for a friends list might present a plurality of images of friends′faces. Upon selection of one of the images, information about that friend may be displayed for viewing and/or editing, or the friend's computer, telephone, PDA, or other device may be contacted by the computer 102. The term “select” as used herein refers to either or both of provisional selection and actual selection, and the distinction will be made only when necessary.

Provisional selection comprises navigating to a selectable item. The provisionally selected item will typically be highlighted to indicate that it has been provisionally selected. For example, in navigating a friends list, one may provisionally select a first friend by pointing a radial input device in an angle corresponding to the location of the friend on a GUI. The friend is highlighted, and can then be actually selected by pushing a selecting button, such as the “enter” key on a keyboard, a double-click with the mouse, or depression of one of the variety of available buttons on a videogame controller. Actual selection will cause the function associated with the provisionally selected item to execute.

Positioning the radial input device 107 at an angle 106 selects an item 104 in the GUI, said item 104 in the GUI positioned at said angle 105. This allows for intuitive, instantaneous selection of any item that is displayed in the GUI at +180 degrees (e.g., 180 degrees clockwise) or −180 degrees (e.g., 180 degrees counterclockwise) away from a currently selected item, simply by pointing the input device 107 at the angle 106 corresponding to the angle 105 of the desired item in the GUI. The terms “clockwise” and “counterclockwise” may be referred to herein a radial directions. For example, clockwise may be understood as a first radial direction while counterclockwise is thought of as a second radial direction, and vice versa.

The computer 102 may be configured to determine a plurality of selectable items appearing on the display 103 based on a currently selected item 104. A “window” of selectable items may be recalculated with each new selection. The window may include, for example, some number of items preceding the currently selected item 104 in a list, and some number of items following the currently selected item 104 in a list. Consider, for example, a hypothetical list of 20 items, and a window that is 8 items wide. When the 10^{th} item in the list is currently selected, the window or plurality of selectable items appearing on the display 103 may comprise the 7^{th} item through the 13^{th} item, inclusive. When the 13^{th} item in the list is currently selected, the window or plurality of selectable items appearing on the display 103 may comprise the 10^{th} item through the 17^{th} item, inclusive. When the 16th item in the list is currently selected, the window or plurality of selectable items appearing on the display 103 may comprise the 13^{th} item through the 20^{th} item, inclusive. The use of an 8 item wide window is completely arbitrary here and for the purpose of illustration.

When items are displayed radially, another way to calculate the selectable items within the window is by determining which items are within some predetermined radial distance from a currently selected item. For example, any items displayed in the GUI at +180 degrees or −180 degrees from a currently selected item may be considered to be among the plurality of selectable items.

In one embodiment, the plurality of selectable items appearing on the display 103 comprise both items preceding and following the currently selected item. This is contemplated in the examples above. However, the plurality of selectable items appearing on the display 103 could comprise only items that are preceding, or only items that are following, or some unbalanced ratio of items preceding and following. Thus, for example, when the currently selected item is at the top of the dataset, the plurality of selectable items appearing on the display 103 could comprise only items that are following the currently selected item (since there are no items preceding the first item). Conversely, when the currently selected item is at the bottom of the dataset, the plurality of selectable items appearing on the display 103 could comprise only items that are preceding the currently selected item. The window can thus slide though the dataset, remaining centered on the currently selected item, and can also slide with reference to the currently selected item when the currently selected item is near the beginning or end of the dataset.

Although not required in all embodiments, it may be generally useful to cause items that are not among the plurality of selectable items to disappear from the display. For example, when a new item is selected, thereby causing the window of selectable items to change, those items that are no longer in the window can disappear from the GUI, while the items that are now within the window can appear. An alternative arrangement in embodiments that display items in a three-dimensional (3D) fashion is to allow items to fade from view in the background. Thus, some items that follow the window of selectable items may be visible, but as the items become further away they become smaller and eventually fade from view.

A paging system or the use of buttons or triggers to change datasets may be used in conjunction with the invention. Similar to the familiar navigation scenario, a button may be used to switch from one dataset to another, then navigation can proceed as described herein. In a paging arrangement, selection of one of the items may cause another dataset to appear, and such dataset may be navigable according to the techniques of the invention or navigable by other means.

One area in which the invention is considered useful is for navigation of a large dataset such as a friends list. A friends list generally comprises information about people comprising the friends, family, business contacts, or other contacts of a user of the system. In one embodiment, the items can be people who are friends from a friends list, and the friends can be represented by names or images. The images may comprise pictures of a person's face to facilitate recognition and selection of the friend.

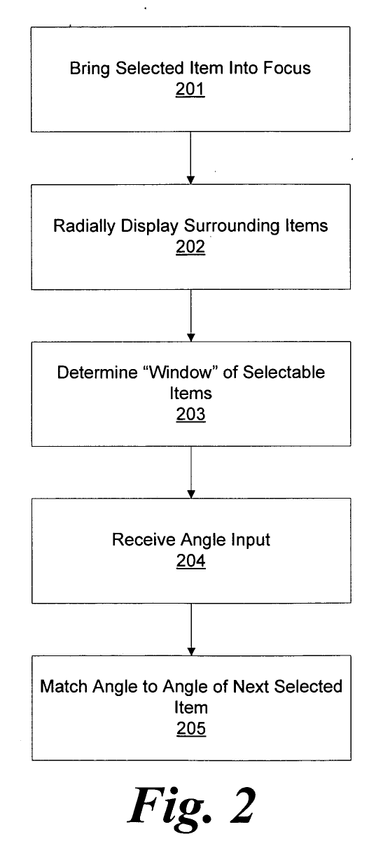

FIG. 2 illustrates a method for displaying a plurality of selectable items. The method is designed to be carried out by a computer such as 102 from FIG. 1. When a user selects an item from the GUI described above, the computer may indicate selection of the currently selected item, for example by highlighting the item, or by moving the item to a particular location or rendering it in a size that indicates it is selected. This is referred to in FIG. 2 as bringing the item into focus 201.

Bringing the item into focus 201 may be accompanied by radially displaying surrounding items 202. Surrounding items are typically some limited number of preceding and following items—the items in the window of selectable items. Radially displaying items comprises displaying the items such that they may be selected by indicating an angle on a radial input device. A first plurality of items preceding the currently selected item in a list of items can be arranged incrementally departing from the currently selected item in a first radial direction; and a second plurality of items following the currently selected item in said list of items, can be arranged incrementally departing from the currently selected item in a second radial direction. For example, the item immediately following the selected item in the list or dataset can be the next item on a circle in the clockwise direction, while the item immediately preceding the selected item in the list or dataset can be the next item on the circle in the counterclockwise direction.

In one embodiment that is described in greater detail below, the items may be radially displayed in step 202 to appear as if they are on a 3D helix or corkscrew with central axis perpendicular to the display. In such an embodiment, the items following the selected item can appear smaller and farther away, while the items preceding the selected item can appear larger and closer. It should be emphasized that the corkscrew is not the only contemplated embodiment of the invention. In another exemplary embodiment, for example, a wheel may be presented such that selection of any of the items on the wheel causes the “window” of selectable items displayed on the wheel to change.

Some or all of the displayed surrounding items may be determined to be among the radially selectable plurality of items in step 203. Step 203 comprises determining those items that are in the window of selectable items. It may be that items are in view that are not selectable. For example, where items are depicted in 3D, there may be more than one item depicted at a particular radially selectable angle. However, if such an item is not determined to be within the radially selectable plurality of items, it will not be selected when the user moves the radial input device to the corresponding angle. Instead, the item that is within the set of selectable items and is also at the chosen angle will be selected. In other embodiments, it may be preferable to only display those items that are selectable.

The method next comprises receiving an input comprising an angle of a radial selection from a radial input device 204. Here, the user indicates a desired angle using a radial input device. A signal generated by the device is sent to the computer. There may be various layers of electronics between the input device and the computer, however the signal that originates at the input device is ultimately delivered to the computer. The computer may then match the selected angle to an angle of a next selected item 205. The next selected item is one of the plurality of selectable surrounding the currently selected item. The computer may then refocus the display to bring the next selected item into focus, and may repeat the steps of the method to ensure that new surrounding items are correctly displayed, a new window of radially selectable items is determined, and so forth.

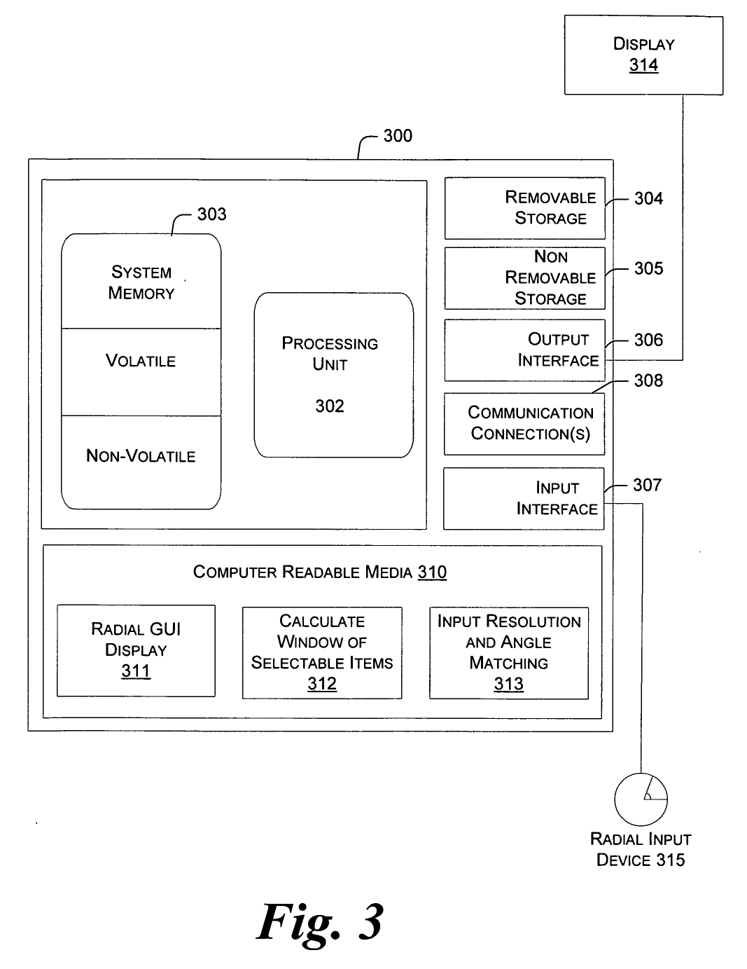

FIG. 3 illustrates an embodiment of the invention in which a computer 300, here, a videogame console, is equipped with appropriate software to carry out various techniques of the invention.

With reference to FIG. 3, an computing device 300 may include a processing unit 302 and memory 303. Depending on the exact configuration and type of computing device, memory 303 may be volatile (such as RAM), non-volatile (such as ROM, flash memory, etc.) or some combination of the two. Additionally, device 300 may also have mass storage (removable 304 and/or non-removable 305) such as magnetic or optical disks or tape. Similarly, device 300 may also have input interfaces 307 that connect to devices such as radial input device 315 and/or output interfaces that connect to output devices such as a display 314. Other aspects of device 300 may include network connections 308 to other devices, computers, networks, servers, etc. using either wired or wireless media.

Computer readable media 310 may be integrated with system memory 303, removable storage 304, non-removable storage 305, or other memory aspects of the computer 300. Computer readable media can comprise a radial GUI display component 311 with instructions for radially displaying a selectable items. GUI display component 311 can comprise instructions for displaying selectable items based on proximity to a selected item, as described above. Component 311 could also determine which items to display based on which items are in the window of selectable items, as calculated by 312. In such an embodiment, 311 and 312 could be integrated into a single software function.

Input resolution and angle matching 313 can comprise instructions for receiving an input comprising a selected angle from a radial input device such as a game controller, and conducting any interpretation needed to properly understand the input. Component 313 may further comprise instructions for matching said selected angle to an angle of a selectable item displayed on the GUI.

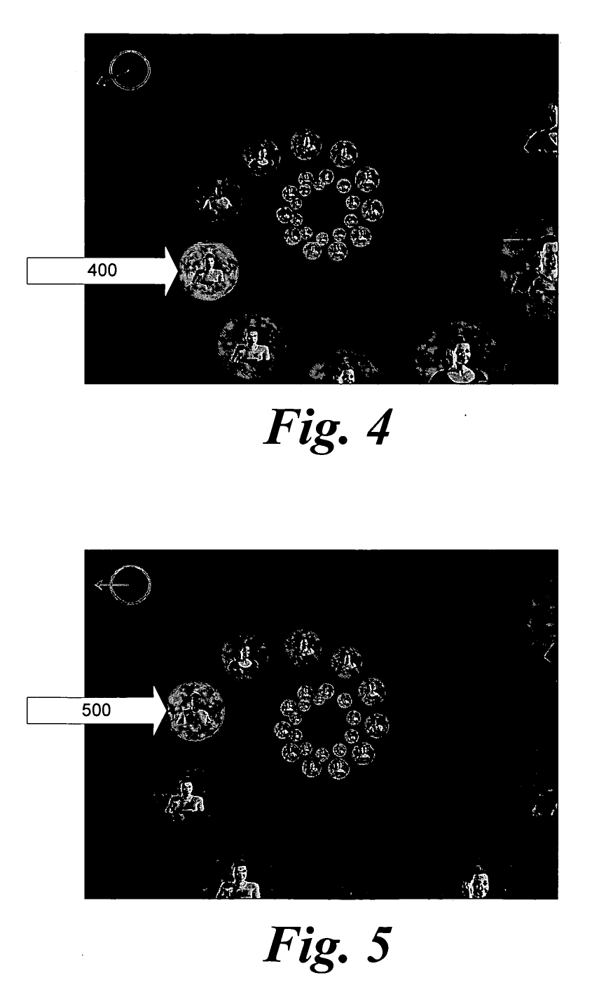

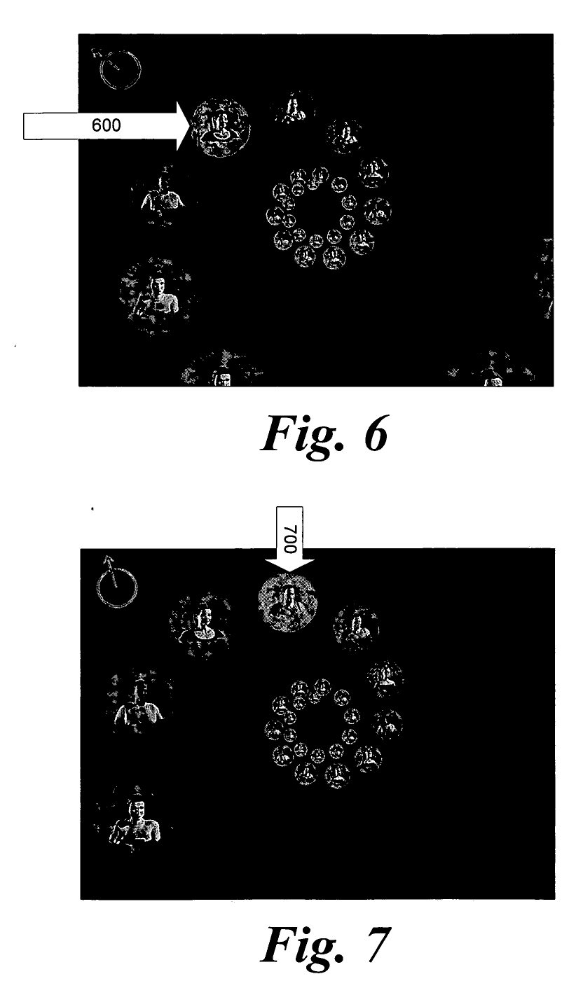

FIGS. 4-7 illustrate screenshots of an exemplary GUI for use in connection with one embodiment of the invention. As can be seen in these figures, the prior art problem of crowding of the radially addressable space is solved by using more than 360 degrees to address the space. Knowing a currently selected item 400 in FIG. 4, immediate selection of any selectable item up to 180 degrees away in either direction can be accomplished using the absolute position of a radial input device (not shown in FIGS. 4-7). For example, in FIG. 4, the friend that is depicted following item 400 is friend 500 from FIG. 5. Friend 500 can be immediately selected by moving a radial selection device to the angle illustrated in the top left corner of FIG. 5. Any of the other friends within 180 degrees of friend 400 could be similarly immediately selected. For example, friend 600 from FIG. 6 and friend 700 from FIG. 7 are both immediately selectable from the initial state illustrated in FIG. 4, by aiming the input device to the angles indicated in the top left corners of the figures. If the state of the input device is sampled quickly enough, then the user can also navigate from the beginning of the set all the way to the end of the set simply by spinning the input device in circles. This allows rapid and exact navigation to the desired element using solely an input device such as a game controller thumbstick.

The navigation illustrated in FIGS. 4-7 is more than simply scrolling through a list of items by spinning the input device clockwise or counter-clockwise. At any given time, the locally addressable items (here, those within 180 degrees in either direction of the currently selected item) can be immediately selected by pointing the thumbstick at the proper angle. A tight relationship between on-screen position and thumbstick angle required for selection can be created, allowing for extremely rapid and intuitive selection.

An implementation of the invention maybe placed within the user interface loop of an application, such as a video game, which is run over and over again quickly enough to be considered under “real time” user control, meaning that the graphical response to user input is seemingly instantaneous to the user. In this embodiment, an algorithm that practices the invention can be broken down into three basic steps:
1. Display the dataset on screen, with the currently selected item as the center of “focus”. The set of elements immediately preceding and following the currently selected item in the array can be laid out in a radial fashion. This set of elements is the current “window” into the larger dataset.
2. Read the user input and match the angle of the input to the onscreen angle of an element from the current window.
3. Refocus the display on the newly selected item, and adjust the “window” into the dataset to be centered around this item.

In embodiments that use the helix with central axis perpendicular to the display, such as FIGS. 4-7, it can be useful to ensure that the angle for each item remains constant over many iterations of the loop in order to enable the instantaneous absolute selection. Thus, the helix need not “spin” as the user navigates down into the dataset. Rather the helix remains in place and the user navigates down through it, like running through a tunnel.

In the exemplary embodiment of FIGS. 4-7, a large dataset is displayed graphically as a helix or corkscrew extending perpendicularly into the display, with the viewpoint looking down the central axis of this corkscrew. The currently selected item is highlighted and the position of the viewpoint is setup to be able to see roughly 180 degrees worth of items that precede and follow the currently highlighted item in the array.

A user input is read from one of the game console's thumbstick controllers, which offer a high resolution analog coordinate from within a circular space. A calculation is performed to determine the angle—from 0 to 360 degrees—at which the thumbstick was pointed. Of the items within 180 degrees in either direction from the currently selected item, the one which most closely matches this angle becomes the next selected item. This gives the user absolute control over the provisional selection highlight on a per-frame basis.

The viewpoint is now moved either forward or backward along the axis of the corkscrew, such that the next selected item is displayed at the same “depth” into the display as the currently selected item was.

The end experience in this prototype is that a user experiences the sensation of navigating up and down a spiral of items. By swirling the thumb stick in a circular fashion, the user can navigate continuously up or down the spiral, and at any time, the user can absolutely position their thumbstick to select an item on screen within 180 degrees of the currently selected item.

In addition to the specific implementations explicitly set forth herein, other aspects and implementations will be apparent to those skilled in the art from consideration of the specification disclosed herein. It is intended that the specification and illustrated implementations be considered as examples only, with a true scope and spirit of the following claims.

1. A system for selecting graphically displayed items comprising:
a computer;
a display operably coupled to said computer, wherein the computer is configured to cause a Graphical User Interface (GUI) comprising a plurality of selectable items to appear on said display;
a radial input device operably coupled to said computer, whereby positioning the radial input device at an angle selects an item in the GUI, said item in the GUI positioned at said angle; and
wherein the computer is configured to determine the plurality of selectable items appearing on said display based on a currently selected item.

2. The system of claim 1, wherein positioning said radial input device at said angle provisionally selects an item in the GUI.

3. The system of claim 1, wherein the computer is configured to determine the plurality of selectable items appearing on said display based on a currently provisionally selected item.

4. The system of claim 1, wherein the computer causes at least one selectable item to disappear from the display when the currently provisionally selected item is provisionally selected.

5. The system of claim 1, wherein the computer causes at least one selectable item to fade from the display when the currently provisionally selected item is provisionally selected.

6. The system of claim 1, wherein the plurality of selectable items comprise people.

7. The system of claim 6, wherein said people are friends from a friends list.

8. The system of claim 6, wherein said people are represented by face images.

9. The system of claim 1, wherein the wherein the computer is configured to cause said Graphical User Interface (GUI) comprising a plurality of selectable items to appear arranged along a helix on said display.

10. The system of claim 9, wherein the computer is configured to cause the central axis of said helix to appear perpendicular to the surface of said display.

11. A method for displaying a plurality of selectable items, comprising:
displaying a currently selected item;
radially displaying a first plurality of items preceding said currently selected item in a list of items, wherein said first plurality of items is arranged incrementally departing from said currently selected item in a first radial direction;
radially displaying a second plurality of items following said currently selected item in said list of items, wherein said second plurality of items is arranged incrementally departing from said currently selected item in a second radial direction;
determining a plurality of selectable items among said first plurality of items and said second plurality of items;
receiving an input comprising an angle of a radial input device;
matching said angle of a radial input device to an angle of a next selected item from said first plurality of items or said second plurality of items.

12. The method of claim 11, wherein said currently selected item and said next selected item are provisionally selected items.

13. The method of claim 11, wherein said first plurality of items is displayed incrementally larger, and said second plurality of items is displayed incrementally smaller, to simulate to a viewer of a display a closer proximity of items that are higher in the list of items.

14. The method of claim 11, wherein said plurality of selectable items comprise people.

15. The method of claim 14, wherein said people are friends from a friends list.

16. The method of claim 14, wherein said people are represented by face images.

17. A video game console comprising computer readable media, said computer readable media comprising:
instructions for radially displaying a first plurality of selectable items;
instructions for receiving an input comprising a selected angle from game controller;
instructions for matching said selected angle to an angle of a selectable item;
instructions for displaying a second plurality of selectable items based proximity to said selectable item in a list of selectable items.

18. The video game console of claim 17, wherein said plurality of selectable items comprise people.

19. The video game console of claim 18, wherein said people are friends from a friends list.

20. The video game console of claim 18, wherein said people are represented by face images.
